(19) United States
(12) Patent Application Publication
(10) Pub. No.: US 2021/0035070 A1
(43) Pub. Date: Feb. 4, 2021

(54) SYSTEMS AND METHODS FOR RECRUITING RETAIL INVESTORS

(71) Applicant: Mark TenPas, Chicago, IL (US)

(72) Inventor: Mark TenPas, Chicago, IL (US)

(21) Appl. No.: 16/935,862

(22) Filed: Jul. 22, 2020

Related U.S. Application Data
(60) Provisional application No. 62/879,768, filed on Jul. 29, 2019.

(51) Int. Cl. G06Q 10/10; G06Q 10/06; G06Q 50/16; G06F 3/0484; G06F 16/955

(52) U.S. Cl. CPC G06Q 10/1053; G06Q 10/06398; G06F 16/9558; G06F 3/04842; G06Q 50/16

(57) ABSTRACT

A retail investor rating and recruiting system including a third-party rating and recruiting system (TPRRS) is disclosed. The TPRRS includes a processor, a storage device, an application programming interface (API) stored in the storage device, wherein the API defines one or more than one command invokable to initiate the transmission of brokerage account trading data from a broker system, associated with one or more than one retail investor, to the TPRRS, and a memory storing program instructions that, when executed by the processor cause the TPRRS to: analyze the brokerage account trading data associated with at least one retail investor to generate at least one of a retail investor performance metric or a retail investor rating for each retail investor, and transmit the at least one of the retail investor performance metric or the retail investor rating to a recipient device.

The present disclosure claims priority to U.S. Provisional Patent Application Ser. No. 62/879,768, filed Jul. 29, 2019, entitled, “SYSTEMS AND METHODS FOR RECRUITING RETAIL INVESTORS,” the entirety of which is incorporated by reference herein.

### BACKGROUND

### Field

The present disclosure generally relates to systems for recruiting retail investors, and more specifically, to systems including an independent third-party rating and recruiting system to rate the performance of individual retail investors based on their historical, current, and/or ongoing brokerage account data such that a recruiter system can access such ratings, via the rating and recruiting system, for hiring purposes and an asset management system can evaluate the trading histories of a select plurality of retail investors, via the rating and recruiting system, for alpha capture purposes.

### Technical Background

Many roadblocks exist, both personal and technological, to prevent an independent third-party from accessing retail investor trading data. For example, a retail investor may want absolute privacy regarding their historical, current and/or ongoing trading data. Accordingly, brokers systems handling retail investor trades have intentionally developed technological barriers to keep individual retail investor trading data private while maintaining technologically easy and secure access to such trading data for their respective retail investors.

Within this backdrop, an interested third-party (e.g., an institutional investor, a portfolio manager, and/or the like) may view an individual retail investor's historical, current, and/or ongoing retail trading data and/or a group of individuals' historical, current, and/or ongoing retail trading data as an untapped resource of knowledge. For example, Warren Buffett's personal brokerage account, at one point, is likely to have looked different than the average retail investor. Unfortunately, no system has existed for any interested third-party to evaluate Warren Buffett's historical, current, and/or ongoing retail trading data or to monitor Warren Buffett's historical, current, and prospective performance to proactively reveal Warren Buffett for what he is known as today, e.g., one of the world's most successful investors. In such an example, Warren Buffett's investment insight represents an opportunity lost to interested third-parties. First, such investment insight, if available, could have been used to appropriately adjust hedge fund strategies and/or equity statistical arbitrage portfolios. Second, interested third-parties were unable to identify Warren Buffett as an intellectual asset to be tracked and/or recruited.

Alpha capture systems fail to capture raw historical, current, and/or ongoing trading data. Instead, alpha capture systems generally rely on investor-supplied information (e.g., returns) which may be used to trade in an equity statistical arbitrage portfolio (e.g., to implement short-term financial trading strategies). Such investor-supplied information is inconvenient to the investor (e.g., having to prepare information for submission to the alpha capture system), and without a third party means of tracking the data, the information may also be suspect. At least since no third-party system has existed to access the historical, current, and/or ongoing trading data of individual retail investors, no third-party system has existed to rate individual retail investors based on their brokerage account trading data. Accordingly, a system is desirable that enables a retail investor to continue to do what he/she already does (e.g., trade in their personal brokerage account) while an independent third-party system privately and continuously evaluates the retail investor's historical, current, and/or ongoing trading data to proactively recognize the retail investor's investment insight and to identify the retail investor as an intellectual asset to be tracked and/or recruited.

### SUMMARY

In one embodiment, a retail investor rating and recruiting system includes a third-party rating and recruiting system (TPRRS) having a processor, a storage device, an application programming interface (API) stored in the storage device, wherein the API defines one or more than one command invokable to initiate the transmission of brokerage account trading data from a broker system, associated with one or more than one retail investor, to the TPRRS, and a memory storing program instructions that, when executed by the processor cause the TPRRS to: analyze the brokerage account trading data associated with at least one retail investor to generate at least one of a retail investor performance metric or a retail investor rating for each retail investor, and transmit the at least one of the retail investor performance metric or the retail investor rating to a recipient device.

In another embodiment, a retail investor rating and recruiting system includes a third-party rating and recruiting system (TPRRS) having a storage device and an application programming interface (API) stored in the storage device, wherein the API defines one or more than one command invokable to initiate the transmission of brokerage account trading data from a broker system to the TPRRS, and wherein the API is downloadable by one or more than one communicatively coupled broker system.

In yet another embodiment, a retail investor rating and recruiting method includes: receiving from a broker system, via an application programming interface (API) of a third-party rating and recruiting system (TPRRS), brokerage account trading data associated with one or more than one retail investor, wherein the API defines one or more than one command invokable to initiate the transmission of the brokerage account trading data from the broker system to the TPRRS, analyzing, by the TPRRS, the brokerage account trading data associated with at least one retail investor to generate at least one of a retail investor performance metric or a retail investor rating for each retail investor, and transmitting, by the TPRRS, the at least one of the retail investor performance metric or the retail investor rating to a recipient device.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1 depicts an illustrative system for rating and recruiting retail investors, according to one or more embodiments shown or described herein;

FIG. 2 depicts an illustrative graphical user interface displayable to consent to use of a broker system API, according to one or more embodiments shown or described herein;

FIG. 3 depicts an illustrative graphical user interface displayable via an investor dashboard application, according to one or more embodiments shown or described herein; and

FIG. 4 depicts a flow diagram of an illustrative method for processing retail investor trading data, according to one or more embodiments shown or described herein.

### DETAILED DESCRIPTION

Various embodiments of the present disclosure relate to computer-based systems and methods including an independent third-party rating and recruiting system to rate the performance of individual retail investors based on their historical, current, and/or ongoing brokerage account data. According to various aspects, a recruiter system may access such ratings, via the rating and recruiting system, for recruiting purposes. According to further aspects, an asset management system may evaluate the trading histories of a select plurality of retail investors, via the rating and recruiting system, for alpha capture purposes.

Various embodiments may be described herein with reference to flowchart illustrations of methods, systems, and computer program products. Each block of the flowchart illustrations, and combinations of blocks in the flowchart illustrations, may be implemented via executable computer program instructions. These computer program instructions may be provided to a processor of a computer or other programmable data processing apparatus to produce a special purpose machine, such that the instructions, which execute via the processor of the computer or other programmable data processing apparatus, create a specific system for implementing the functions specified in a flowchart block and/or various combinations of blocks.

The computer program instructions may be stored in a non-transitory computer-readable memory that can direct or cause the computer or other programmable data processing apparatus to function in a particular manner. In such aspects, the computer program instructions stored in the non-transitory computer-readable memory may define a computer program product (e.g., a manufacture). The computer program instructions of the computer program product, when executed by a processor of the computer or other programmable data processing apparatus may implement the functions specified in a flowchart block and/or various combinations of blocks in the flowchart illustrations as described herein.

The computer program instructions may also be loaded onto the computer or other programmable data processing apparatus to cause a series of operational steps to be performed on the computer or other programmable data processing apparatus to produce a computer-implemented process such that the computer program instructions which execute on the computer or other programmable data processing apparatus provide steps for implementing the functions specified in a flowchart block and/or various combinations of blocks in the flowchart illustrations as described herein.

Various embodiments described herein may include a computer (e.g., server) specially configured or configured as a computer with the requisite hardware, software, and/or firmware. The computer may include a processor, input/output hardware, network interface hardware, a data storage component (e.g., storage device, database, and/or the like), and a memory component configured as volatile or non-volatile memory including RAM (e.g., SRAM, DRAM, and/or other types of random access memory), flash memory, registers, compact discs (CDs), digital versatile discs (DVD), and/or other types of storage components. In line with above, the memory component may also include operating logic that, when executed, facilitates the operations described herein. The processor may include any processing component configured to receive and execute instructions (such as from the data storage component and/or memory component). The network interface hardware may include any wired/wireless hardware generally known to those of skill in the art for communicating with other networks and/or devices.

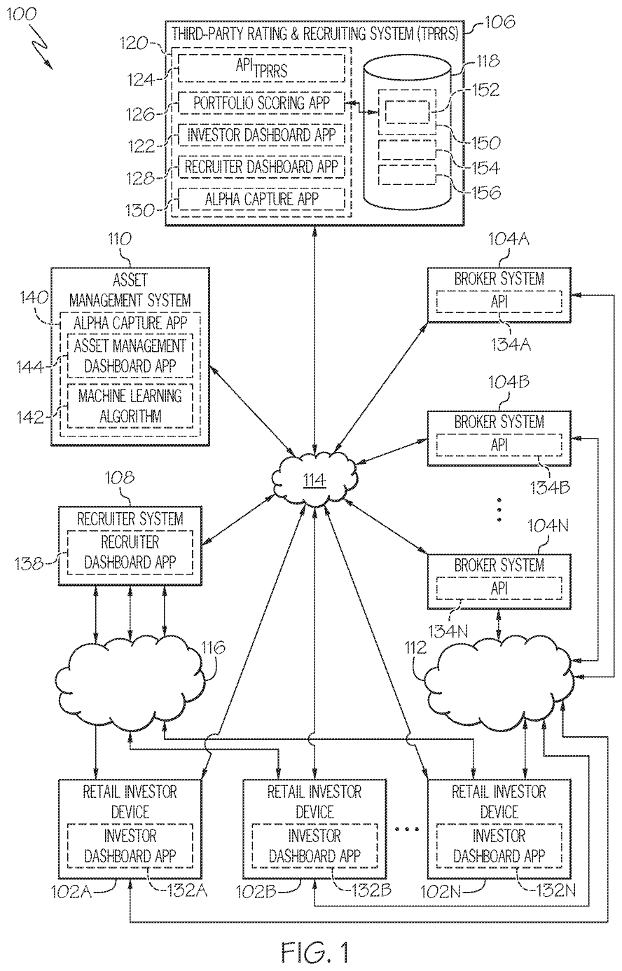

FIG. 1 depicts an illustrative retail investor rating and recruiting system 100, according to one or more embodiments of the present disclosure. The retail investor rating and recruiting system 100 may include a plurality of retail investor devices (e.g., retail investor device 102A, retail investor device 102B, retail investor device 102N), a plurality of broker systems (e.g., Broker System 104A, Broker System 104B, Broker System 104N), a third-party rating and recruiting system (TPRRS) 106, a recruiter system 108, and an asset management system 110. Each of the plurality of retail investor devices 102A, 102B, 102N, the plurality of broker systems 104A, 104B, 104N, the TPRRS 106, the recruiter system 108, and the asset management system 110 may include a computer or other programmable data processing apparatus as described herein (e.g., specially configured, having a processor executing computer program instructions, and/or the like).

Retail Investor Devices and Broker Systems

Referring to FIG. 1, each of the plurality of retail investor devices 102A, 102B, 102N may be communicatively coupled (e.g., via a network infrastructure 112 and/or a network infrastructure 114) to their respective broker systems 104A, 104B, 104N and to the TPRRS 106 (e.g., via the network infrastructure 114). Each retail investor device 102A, 102B, 102N, as described herein, may include a computer (e.g., a personal computer, a tablet, a cellular phone, and/or the like). According to some aspects, as described herein, each of the plurality of retail investor devices 102A, 102B, 102N may be communicatively coupled to at least one recruiter system 108 (e.g., via the network infrastructure 114 and/or a network infrastructure 116). According to various aspects, the network infrastructure 112, the network infrastructure 114, and the network infrastructure 116 may refer to the same network infrastructure. According to other aspects, one or more than one of the network infrastructure 112, the network infrastructure 114, and the network infrastructure 116 may refer to a different network infrastructure. A network infrastructure, as described herein, may include without limitation a wide area network (WAN), such as the Internet, a local area network (LAN) such as an Ethernet, a mobile communications network, a public service telephone network (PSTN), a personal area network (PAN), a metropolitan area network (MAN), a virtual private network (VPN), and/or another network. Such a network infrastructure may electronically connect one or more devices such as computers and/or components thereof.

Broker Systems and the TPRRS

Each broker system 104A, 104B, 104N of FIG. 1 may be further communicatively coupled (e.g., via a network infrastructure 114) to the TPRRS 106. Each broker system 104A, 104B, 104N may include one or more than one computer (e.g., computer, server, web server, and/or the like) associated with a particular broker (e.g., TD Ameritrade®, Fidelity Investments®, Charles Schwab®, E*TRADE®, Interactive Brokers℠, Merrill Edge℠, TradeStation℠, and/or the like). Each broker system 104A, 104B, 104N may include a respective application programming interface (e.g., API 134A of Broker System 104A, API 134B of Broker System 104B, API 134N of Broker System 104N, and/or the like) specifically configured to complete the transfer of brokerage account trading data, as described more fully herein.

According to aspects of the present disclosure, each communicative link between each broker system 104A, 104B, 104N and the TPRRS 106 (e.g., as depicted in FIG. 1) may not be established until at least one retail investor (e.g., Retail Investor A, Retail Investor B, Retail Investor N, and/or the like) affiliated with their respective broker system 104A, 104B, 104N initiates and/or consents to the transmission of specified brokerage account trading data from the respective broker system 104A, 104B, 104N to the TPRRS 106. As discussed herein, prior to the systems and/or methods of the present disclosure, no system has existed to realize the transfer of retail investor brokerage account trading data to an independent third-party system (e.g., TPRRS 106). Here, for purposes of the present disclosure, “independent” and “third-party” may reference a system and/or entity that is not affiliated with and/or not under the control of another system and/or entity of the retail investor rating and recruiting system 100, as described herein. More specifically, prior to the systems and/or methods of the present disclosure, the broker systems 104A, 104B, 104N would not have been communicatively coupled to any TPRRS 106, as described herein.

In light of FIG. 1, the systems and/or methods of the present disclosure enable the transfer of specified retail investor brokerage account trading data to a TPRRS 106. For example, after being apprised (e.g., via advertising and/or the like) of the TPRRS 106, Retail Investor A may communicate, via retail investor device 102A (e.g., cell phone) and network infrastructure 112 (e.g., a mobile communication network) with Broker System 104A (e.g., Fidelity Investments®). In such an example, Retail Investor A may instruct Broker System 104A to transmit Retail Investor A's brokerage account trading data to the TPRRS 106. According to various aspects, the instruction may pertain to the transmission of Retail Investor A's historical trading data, Retail Investor A's current trading data, and/or Retail Investor A's ongoing trading data. Continuing the example, Broker System 104A may transmit (e.g., via network infrastructure 112 and/or network infrastructure 114) a graphical user interface (GUI) displayable on retail investor device 102A for Retail Investor A to memorialize the instruction and to consent to the use of Broker System's 104A application programming interface, API 134A, to transmit the specified retail investor brokerage account trading data (e.g., historical, current, and/or ongoing) to the TPRRS 106.

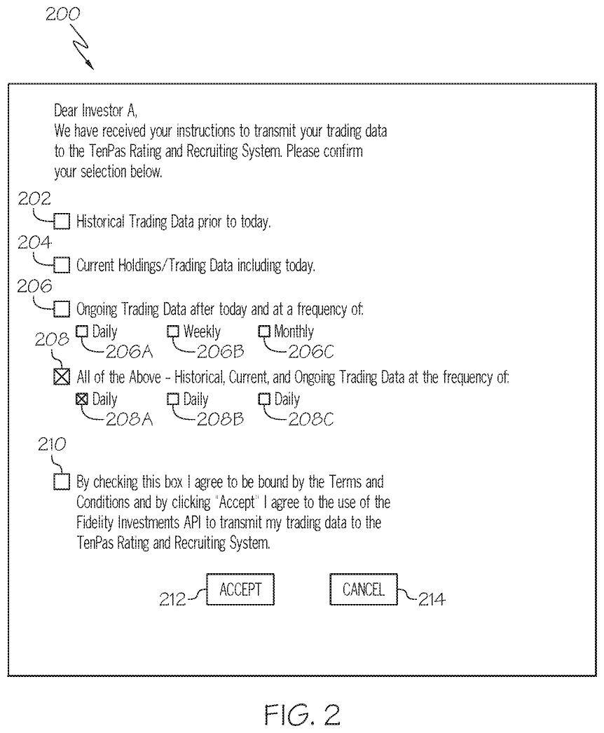

FIG. 2 depicts an illustrative GUI 200 to consent to use of a broker system API (e.g. API 134A of Broker System 104A) according to one or more embodiments of the present disclosure. Referring to FIG. 2, the GUI 200 may be configured such that a retail investor (e.g., Retail Investor A) may select a first check box 202 to transmit their historical brokerage account trading data (e.g., trading data “prior to today”), a second check box 204 to transmit their current brokerage account holdings and trading data (e.g., holdings/trading data “including today”), a third check box 206 to transmit their ongoing brokerage account trading data (e.g., trading data “after today”), or a fourth check box 208 to transmit their historical, current and ongoing brokerage account trading data. In such an aspect, if the third check box 206 or the fourth check box 208 is selected, the GUI 200 may be configured such that the investor may select a first sub-check box 206A, 208A to transmit the ongoing trading data daily, a second sub-check box 206B, 208B to transmit the ongoing trading data weekly, or a third sub-check box 206C, 208C to transmit the ongoing trading data monthly. Here, it should be understood that the GUI 200 may be configured to designate other transmission periods and/or triggers (e.g., in real or near-real time, hourly, a specific time each day, each week, or each month, every “X” calendar days, every “Y” business days, every “Z” trading days, each time a trade is executed, on-demand from a TPRRS 106, and/or the like). Referring to FIG. 2, the retail investor (e.g., Retail Investor A) has selected the fourth check box 208 to instruct the transmission of their historical trading data, their current trading data, and their ongoing trading data as well as the first sub-check box 208A to transmit their ongoing trading data daily. The GUI 200 may be further configured such that the investor may select a fifth check box 210 to consent to the specified transmission of trading data (e.g., including to be bound by broker “Terms and Conditions”, and/or the like) as well as the use of an API (e.g., “Fidelity Investments API”, API 134A) to transmit the specified trading data to a TPRRS 106 (e.g., the “TenPas Rating and Recruiting System”). Referring still to FIG. 2, the GUI 200 may be configured such that the retail investor may select an “Accept” button 212 to confirm the instructions as specified or a “Cancel” button 214 to cancel the instructions as specified. According to various aspects, the GUI 200 may be provided with various check boxes (e.g., 208, 208A) preselected based on a separate instruction received from the retail investor.

Referring again to FIG. 1, Broker System 104A may include API 134A, Broker System 104B may include API 134B, and Broker System 104N may include API 134N.

According to various aspects of the present disclosure, each API 134A, 134B, 134N may be a TPRRS-supplied API (e.g., API_{TPRRS} 124). In such an aspect, each broker system 104A, 104B, 104N may download (e.g., via network infrastructure 114) the API_{TPRRS} 124 from a storage device 120 of the TPRRS 106. According to various aspects, each broker system 104A, 104B, 104N may download the API_{TPRRS} 124 after receiving a request from at least one retail investor to transmit the at least one retail investor's brokerage account trading data to the TPRRS 106. According to such aspects, downloading the API_{TPRRS} 124 enables each broker system 104A, 104B, 104N to quickly and efficiently begin the requested transmission of the at least one retail investor's brokerage account trading data to the TPRRS 106 without requiring costly modifications to existing hardware and/or software of each broker system 104A, 104B, 104N. According to other aspects of the present disclosure, each API 134A, 134B, 134N may be a broker system-specific API. In such an aspect, each broker system 104A, 104B, 104N may configure its own respective API 134A, 134B, 134N to transmit the at least one retail investor's brokerage account trading data to the TPRRS 106. According to such aspects, each broker system 104A, 104B, 104N may tailor its respective API 134A, 134B, 134N to address broker-system specific concerns (e.g., security, integration with legacy systems, and/or the like). In yet other aspects of the present disclosure, each API 134A, 134B, 134N may be a hybrid API. In such aspects, each broker system 104A, 104B, 104N may download the API_{TPRRS} 124 and customize the API_{TPRRS} 124 to integrate with its respective broker system 104A, 104B, 104N to transmit the at least one retail investor's brokerage account trading data to the TPRRS 106. In view of FIG. 1, the retail investor brokerage account trading data (e.g., historical, current, and/or ongoing) transmitted from each broker system 104A, 104B, 104N may be stored in a database 118 of the TPRRS 106.

Regardless of whether the API is a TPRRS-supplied API, a broker system-specific API or a hybrid API, the API may define one or more than one specific command that may be invoked by the TPRRS 106 to request trading data associated with a specific retail investor from the one or more than broker systems 104A, 104B, 104N (e.g., on demand). Similarly, the API may define one or more than one specific command that may be invoked by each broker system 104A, 104B, 104N to transmit a specific retail investor's trading data to the TPRRS 106 (e.g., as instructed). The API may be configured according to a suitable standard or protocol to enable the communication of trading data, as described herein, between the various broker systems 104A, 104B, 104N and the TPRRS 106. According to some aspects, the API may be configured to receive commands formatted according to a suitable format including, for example, Extensible Markup Language (XML), HyperText Markup Language (HTML), JavaScript Object Notation (JSON), an Interface Description Language (e.g., Apache Thrift IDL, Android IDL, and/or the like), or the like.

Still referring to FIG. 1, the TPRRS 106 may be communicatively coupled (e.g., via network infrastructure 114) to the recruiter system 108 and the asset management system 110. It should be understood that, according to various aspects, the recruiter system 108 may include a plurality of recruiter systems and/or the asset management system 110 may include a plurality of asset management systems. For ease of description, only one recruiter system 108 and one asset management system 110 is described herein.

TPRRS and Asset Management System

According to aspects described herein, the communicative link between the TPRRS 106 and the asset management system 110 (e.g., as depicted in FIG. 1) may be established by a user (e.g., institutional investor, portfolio manager, and/or the like) associated with the asset management system 110. For example, after being apprised (e.g., via advertising and/or the like) of the TPRRS 106, the user associated with the asset management system 110 may initiate communication (e.g., via network interface 114) with the TPRRS 106 to evaluate the brokerage account trading data (e.g., historical, current and/or ongoing) of one or more than one select retail investor to develop an alpha capture strategy. More specifically, the asset management system 110 may download (e.g., via the network infrastructure 114) the trading data of one or more than one select retail investor. In such aspects, each set of trading data may be associated with a unique identifier, as described herein, such that its corresponding retail investor's identity may remain anonymous to the asset management system 110. According to various aspects, the asset management system 110 may include an alpha capture application 140. In some aspects, the alpha capture application 140 may include a machine learning algorithm 142 (e.g., Adaptive Boosting, a Boosted Gradient Regression, a Support Vector Machine, and/or the like). In such aspects, the machine learning algorithm 142 may rate, weight, and/or combine the trading data associated with the one or more than one select retail investor to generate a signal or alpha for application to a statistical arbitrage portfolio, a systematic strategy portfolio, a quantitative strategy portfolio, and/or the like. Further in such aspects, for example, the generated signal or alpha may be fed into a long/short equity statistical arbitrage portfolio optimizer and the portfolio may be actively traded in the relevant market. In some aspects, the alpha capture application 140 may further include an asset management dashboard application 144 (e.g., similar to the recruiter dashboard application 138 as described herein) for the asset management system to select one or more than one retail investor for alpha formulation. According to various aspects, each retail investor may be tracked (e.g., via their respective unique identifier), on an ongoing basis, to assess consistent positive specific returns (e.g., risk factor timing returns). In some aspects each retail investor's relative contribution with respect to the machine learning algorithm outputs may also be tracked. According to such aspects, the asset management system 110 may disburse an incentive fee and/or prize money to a retail investor (e.g., via the TPRRS 106 using their respective unique identifier) based on their respective relative contribution(s) to the machine learning algorithm outputs (e.g., signal or alpha). The alpha is a mapping from securities to positive or negative real numbers. These real numbers describe an expected direction of stocks' movements and provide signals to buy or sell.

TPRRS and Recruiter System

According to aspects of the present disclosure, the communicative link between the TPRRS 106 and the recruiter system 108 (e.g., as depicted in FIG. 1) may not be established until at least one retail investor (e.g., Retail Investor A, Retail Investor B, Retail Investor N, and/or the like) associated with respective retail investor device 102A, 102B, 102N prompts the recruiter system 108 to communicate with the TPRRS 106. As discussed herein, prior to the systems and/or methods of the present disclosure, no system has existed to realize the transfer of retail investor brokerage account trading data to a TPRRS 106. Accordingly, prior to the systems and/or methods of the present disclosure, a recruiter system 108 would not be in communication with the TPRRS 106 and such a communicative link would need to be established. According to various aspects described herein, the recruiter system 108 may include an independent recruiter system 108 that is not affiliated with and/or under the control of any employer. According to other aspects described herein, the recruiter system 108 may include an in-house recruiter system 108 that is affiliated with and/or under the control of an employer (e.g., a human resources system and/or the like). In one aspect, the recruiter system 108 may be affiliated with and/or under the control of the asset management system 110 (e.g., interested in hiring asset managers).

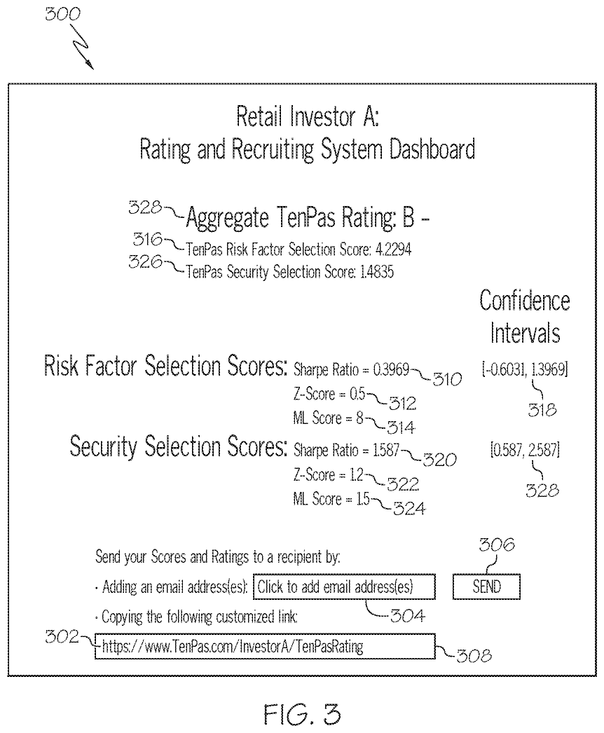

According to some aspects (e.g., to prompt a recruiter system 108 to communicate with the TPRRS 106), a retail investor device (e.g., retail investor device 102A) may be configured to transmit (e.g., via network infrastructure 114 and/or network infrastructure 116) a hyperlink configured to direct a recipient (e.g., a recruiter associated with the recruiter system 108) to the TPRRS 106. FIG. 3 depicts an illustrative graphical user interface 300 displayable via an investor dashboard application (e.g., investor dashboard application 132A) on a retail investor device (e.g. retail investor device 102A), according to one or more embodiments of the present disclosure. In particular, the investor dashboard application (e.g., investor dashboard application 132A) may be configured to communicate with the TPRRS 106 to receive a customized hyperlink 302 generated by the TPRRS 106 for the retail investor (e.g., Retail Investor A) associated with the retail investor device (e.g., retail investor device 102A).

Referring to FIG. 3, the illustrative GUI 300 may be configured to display an email text box 304. In such an aspect, the retail investor (e.g., Retail Investor A) may transmit their customized hyperlink 302 to a recipient (e.g., the recruiter associated with the recruiter system 108) by clicking on the email text box 304 and adding one or more than one recipient email address (e.g., recruiter email address). In such an example, after selecting the send control element 306, the investor dashboard application (e.g., investor dashboard application 132A) may be configured to copy Retail Investor A's customized hyperlink 302 into a predefined or form email and to send the predefined or form email to the recipient (e.g., recruiter at the recruiter system 108). According to various aspects, the investor dashboard application (e.g., investor dashboard application 132A) may be configured to send the predefined or form email using a default email account on the retail investor device (e.g., retail investor device 102A). In such aspects, the recipient (e.g., recruiter associated with the recruiter system 108) may enter the customized hyperlink 302 (e.g., from the predefined or form email) into a web browser and/or select the customized hyperlink 302 (e.g., from the predefined or form email) to initiate communication with the TPRRS 106 and/or to access the retail investor's (e.g., Retail Investor A's) performance metrics and/or ratings, as described herein. According to various aspects, the retail investor may receive an email confirmation (e.g., from the TPRRS 106 via network infrastructure 114) when the customized hyperlink 302 has been used by the recipient(s) to access the retail investor's performance metrics and/or ratings.

According to further aspects (e.g., to prompt a recruiter system 108 to communicate with the TPRRS 106), a retail investor device (e.g., retail investor device 102A) itself may be configured to provide the customized hyperlink 302 to the investor (e.g., Investor A). In particular, the investor dashboard application (e.g., investor dashboard application 132A) may be configured to communicate with the TPRRS 106 to receive the customized hyperlink 302 generated by the TPRRS 106 for the retail investor (e.g., Retail Investor A) associated with the retail investor device (e.g., retail investor device 102A). Referring again to FIG. 3, the illustrative graphical user interface 300 may be configured to provide a customized hyperlink text box 308 that depicts Investor A's customized hyperlink 302. In such an aspect, Investor A may prompt a recipient (e.g., the recruiter associated with the recruiter system 108) to communicate with the TPRRS 106 by copying their customized hyperlink 302 into a document (e.g., a personal email, a physical and/or electronic resume, and/or the like) and/or an employment website (e.g. LinkedIn®, and/or the like) such that the recipient (e.g., recruiter associated with the recruiter system 108) may enter the customized hyperlink 302 (e.g., from the physical resume and/or the like) into a web browser and/or select the customized hyperlink 302 (e.g., from the electronic resume, in the personal email, on the employment website, and/or the like) to initiate communication with the TPRRS 106 and/or to access the retail investor's (e.g., Investor A's) performance metrics and/or ratings, as described herein. According to various aspects, the retail investor may receive an email confirmation (e.g., from the TPRRS 106 via network infrastructure 114) when the customized hyperlink 302 has been used by the recipient(s) to access the retail investor's performance metrics and/or ratings.

According to other aspects of the present disclosure, the communicative link between the TPRRS 106 and the recruiter system 108 (e.g., as depicted in FIG. 1) may be established prior to any prompting by at least one retail investor (e.g., Retail Investor A, Retail Investor B, Retail Investor N, and/or the like) associated with respective retail investor device 102A, 102B, 102N to communicate with the TPRRS 106. For example, after being apprised (e.g., via advertising and/or the like) of the TPRRS 106, a recruiter associated with the recruiter system 108 may initiate communication (e.g., via network interface 114) with the TPRRS 106 to access one or more than one performance metric and/or rating associated with one or more than one respective prospective recruit or hire.

Accordingly, after such communicative links are established, the TPRRS 106 may act as a service provider to the retail investor devices 102A, 102B, 102N (e.g., to Retail Investor A, Retail Investor B, Retail Investor N), to the recruiter system(s) 108 (e.g., to recruiters), and/or to the asset management system(s) 110 (e.g., to institutional investors, portfolio managers, and/or the like). Here, although the TPRRS 106 may provide its API_{TPRRS} 124 to each broker system 104A, 104B, 104N, as described herein, the TPRRS 106 may not generally act as a service provider to each broker system 104A, 104B, 104N. Rather, each broker system 104A, 104B, 104N may generally act as a data source (e.g., a retail investor brokerage account trading data source) to the TPRRS 106.

Investor Dashboard, Recruiter Dashboard, and Alpha Capture Applications

As a service provider, in view of FIG. 1, the storage device 120 of the TPRRS 106 may further store an investor dashboard application 122, a recruiter dashboard application 128, and an alpha capture application 130.

According to aspects of the present disclosure, each retail investor device 102A, 102B, 102N may download (e.g., via the network infrastructure 114) the investor dashboard application 122 from the storage device 120 for execution on each retail investor device 102A, 102B, 102N as investor dashboard application 132A, 132B, 132N, respectively. Downloading the investor dashboard application 122 enables each retail investor (e.g. Retail Investor A, Retail Investor B, Retail Investor N) of each retail investor device 102A, 102B, 102N to quickly and efficiently evaluate their performance metrics and/or ratings, as described herein, without requiring costly modifications to existing hardware and/or software of each retail investor device 102A, 102B, 102N. In light of FIG. 3, each investor dashboard application 132A, 132B, 132N may be configured such that its respective retail investor (e.g., Retail Investor A, Retail Investor B, Retail Investor N) may track not only their respective individual performance metrics (e.g., as calculated by the TPRRS 106) but also their respective investor ratings (e.g., as determined by the TPRRS 106).

Similarly, the recruiter system(s) 108 may download (e.g., via network infrastructure 114) the recruiter dashboard application 128 (e.g., after being prompted via a customized hyperlink 302, an advertisement, and/or the like) from the storage device 120 for execution on the recruiter system(s) 108 as recruiter dashboard application 138. Downloading the recruiter dashboard application 128 enables the recruiter system(s) 108 to quickly and efficiently evaluate a particular retail investor's performance metrics and/or ratings (e.g., associated with an investor's customized link 302) and/or a plurality of investors' performance metrics and/or ratings, as described herein, without requiring costly modifications to existing hardware and/or software of the recruiting system(s) 108.

Likewise, the asset management system(s) 110 may download (e.g., via network infrastructure 114) the alpha capture application 130 from the storage device 120 for execution on the asset management system(s) 110 as alpha capture application 140. Downloading the alpha capture application 130 enables the asset management system(s) 110 to quickly and efficiently formulate alpha strategies, as described herein, without requiring costly modifications to existing hardware and/or software of the asset management system(s) 110.

Portfolio Scoring Application

Referring again to FIG. 1, the storage device 120 of the TPRRS 106 may further store a portfolio scoring application 126. The portfolio scoring application 126 may access retail investor brokerage account trading data (e.g., historical, current, and/or ongoing) as transmitted from each broker system 104A, 104B, 104N and as stored in the database 118 of the TPRRS 106.

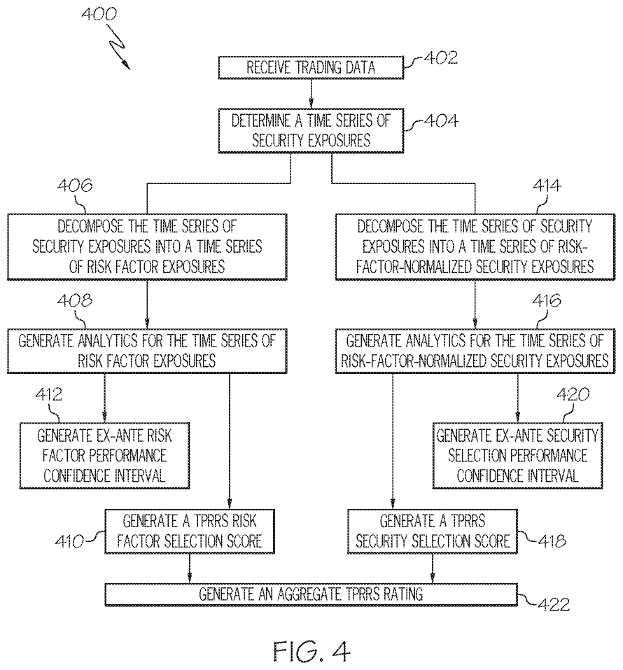

FIG. 4 depicts a flow diagram of an illustrative method for processing retail investor brokerage account trading data, according to one or more embodiments of the present disclosure. At block 402, trading data associated with a retail investor (e.g., Retail Investor A) may be received (e.g., via network infrastructure 114) by the TPRRS 106 from a broker system (e.g., broker system 104A). In such an aspect, as described herein, an API (e.g., API 134A) associated with the broker system (e.g., broker system 104A) may be configured to transmit the retail investor's (e.g., Retail Investor A's) historical, current, and/or ongoing trading data to the TPRRS 106. In some aspects, the API (e.g., API 134A) may be configured to automatically push the retail investor's trading data to the TPRRS 106. In other aspects, the API (e.g., API 134A) may be configured to transmit the retail investor's trading data upon and/or after a request (e.g., generated by the portfolio scoring application 126) from the TPRRS 106.

After receipt, the retail investor trading data may be stored (e.g., in raw form) in the database 118 in a retail investor sub-file 152 of a retail investor trading data file 150. Each retail investor utilizing the services of the TPRRS 106, as described herein, may be associated with a separate retail investor sub-file 152. According to various aspects, each retail investor may be assigned a unique identifier such that their associated trading data can remain anonymous during various uses, as described herein. In such aspects, the database 118 may further include a look-up file 154 including a table that stores each retail investor's information in association with their unique identifier for use by the TPRRS 106 (e.g., when providing individual retail investor performance metrics and/or ratings via the investor dashboard applications, the recruiter dashboard application, and/or the like).

According to various aspects, the portfolio scoring application 126 may access the trading data of one or more than one retail investor stored in the database 118. In some aspects, based on predefined constraints, the portfolio scoring application 126 may be configured to include stored trading data and/or exclude stored trading data during its analyses as described herein (e.g., See Examples section herein). In some aspects, the portfolio scoring application 126 may be configured to generate, using a retail investor's trading data, a two-dimensional array. In such aspects, a first dimension of the two-dimensional array may include a universe of financial instruments (e.g., associated with a stock index) including each financial instrument (e.g., security) of the retail investor's portfolio and a second dimension of the two-dimensional array may include a set of dates (e.g., Oct. 26, 2018-Dec. 26, 2018) and/or dates and times (e.g., Oct. 26, 2018, 09:24:16) associated with each trade of each financial instrument. Further in such aspects, the two-dimensional array may be populated with the retail investor's exposures in each financial instrument. According to various aspects described herein, such exposures may be based on the retail investors (e.g., Retail Investor A's) trades at specified times, based on the retail investor's current holdings, and/or based on an exponential moving average of the retail investor's trades and/or holdings. Although the discussions herein may pertain to a particular type of financial instrument (e.g., a security, a stock), it should be understood that the systems and methods described herein may similarly apply to other types of financial instruments (e.g., bonds, derivatives, and/or the like).

At block 404, the portfolio scoring application 126 may determine the exposure of the retail investor's portfolio to each security over time (e.g., a time series of security exposures). Each exposure may include an amount and/or a percentage of the retail investor's portfolio invested in the respective security. For example, according to various aspects, the portfolio scoring application 126 may, based on the investor's two-dimensional array, compute a vector of the retail investor's security exposures by date and time.

At block 406, the portfolio scoring application 126 may decompose the time series of security exposures into a time series of risk factor exposures. According to various aspects a series of known risk factors (e.g., style, industry, country, and/or the like) may be stored in a risk factor file 156 of the database 118 by security and date.

Style risk factors may include, but are not limited to the following: beta coefficient, momentum and/or reversal, value, liquidity, size, yield, and residual volatility. Initially, the beta coefficient measures each security's volatility relative to its related market. Namely, if beta is equal to 1 the respective security is equally as volatile as its related market and generally does not increase or decrease the risk of its portfolio, if beta is less than 1 the respective security is less volatile than its related market and generally decreases the risk of its portfolio, and if beta is more than 1 the respective security is more volatile than its related market and generally increases the risk of its portfolio. Next, momentum and/or reversal assess each security's historical return over different periods of time (e.g., one month, one year, and/or the like). Next, value measures an equity value (e.g., enterprise value plus cash, cash equivalents, long-term investments, and short-term investments less long-term debt, short-term debt, and minority interests) of the firm associated with each security relative to the market capitalization (e.g., total market value of all outstanding shares) of the firm. A security associated with a relatively higher firm value may generally decrease the risk of its portfolio while a security associated with a relatively lower firm value may increase the risk of its portfolio. According to various aspects, the value may be scaled by a function (e.g. a log function, a logit function, and/or the like) and/or the value may be ranked versus the values associated with other securities in the retail investor's portfolio. Next, liquidity measures a dollar volume of trading in each security over a period of time to assess the degree to which the security may be quickly bought or sold. A security with relatively high liquidity generally decreases the risk of its portfolio while a security with relatively lower liquidity generally increases the risk of its portfolio. According to various aspects, the liquidity may be scaled by a function (e.g. a log function, a logit function, and/or the like) and/or the liquidity may be ranked versus the liquidity associated with other securities in the retail investor's portfolio. Next, firm size measures a market capitalization (e.g., total number of shares outstanding multiplied by the current market share price) of the firm associated with each security. A security associated with a relatively higher firm size may generally decrease the risk of its portfolio while a security associated with a relatively lower firm size may increase the risk of its portfolio. According to various aspects, the firm size may be scaled by a function (e.g. a log function, a logit function, and/or the like) and/or the firm size may be ranked versus the firm size associated with other securities in the retail investor's portfolio. Next, yield measures a percentage of cash returned (e.g., as interest and/or dividends) for each security. A security associated with a relatively higher yield may generally increase the risk of its portfolio while a security associated with a relatively lower yield may generally decrease the risk of its portfolio. According to various aspects, the yield of each security may be scaled by a function (e.g. a log function, a logit function, and/or the like) and/or the yield may be ranked versus the yield associated with other securities in the retail investor's portfolio. Lastly, residual volatility assesses the standard deviation and/or the mean absolute deviation of each security's current market share price.

Industry risk factors and country (e.g., geographic) risk factors may include, but are not limited to, a beta coefficient or an indicator function. According to various aspects, a predetermined beta coefficient may be assigned to each industry and/or each country. In such aspects, the look-up file 154 of the database 118 may include a table that stores each industry in association with its respective predetermined beta coefficient and each country in association with its respective predetermined beta coefficient. Furthermore, in the risk factor file 156 of the database 118, each security may be associated with a Boolean 1 or 0 to indicate the industry associated with that security. Similarly, in the risk factor file 156, each security may be associated with a Boolean 1 or 0 to indicate the country associated with that security (e.g., company associated with that security is based in that country).

Further, at block 406, to decompose the time series of security exposures into a time series of risk factor exposures, the portfolio scoring application 126 may compute, for each risk factor (e.g., style, industry, country, and/or the like), the retail investor's risk factor exposure for each security, multiply each computed risk factor exposure by the security's exposure in the portfolio for that date, and sum the result for across all securities in the portfolio.

At block 408, the portfolio scoring application 126 may generate analytics (e.g., daily time series analytics) based on the retail investor's time series of risk factor exposures to evaluate the retail investor's (e.g., Retail Investor A's) historical risk factor selection ability and/or performance. More specifically, various returns attributable to the risk factors may be computed by the portfolio scoring application 126 and various analytics may be generated by the portfolio scoring application 126 based on the investor's risk factor exposures by day and attribution by risk factor exposure by day. Such analytics may be generally referred to herein risk factor selection scores.

According to some aspects, the portfolio scoring application 126 may calculate the Sharpe ratio of the retail investor's returns (e.g., past performance) from the risk factor exposures (e.g., Sharpe Ratio 310 of FIG. 3). The Sharpe ratio subtracts the risk-free rate of return from the portfolio's mean return to evaluate its profits as associated with risk-taking activities (e.g., a risk-adjusted return of the portfolio). A portfolio associated with a relatively higher Sharpe ratio has a more desired risk-adjusted performance when compared to similar portfolios with relatively lower Sharpe ratios. A portfolio associated with a negative Sharpe ratio has an undesired risk-adjusted performance (e.g., the risk-free rate of return is higher than the portfolio's mean return). The Sharpe ratio may be used to determine whether a portfolio's returns are the result of calculated investment decisions or the result of excessive risk. In other aspects, the portfolio scoring application 126 may calculate the retail investor's returns attributed to each risk factor exposure (e.g., style, industry, country, geographic, and/or the like). In further aspects, the portfolio scoring application 126 may assess the retail investor's ability to predict risk factor returns relative to other retail investors (e.g., Retail Investor B, Retail Investor N, and/or the like).

According to other aspects, the portfolio scoring application 126 may z-score each retail investor's risk factor exposures on a time-wise basis (e.g., Z-Score 312 of FIG. 3). A z-score is a measure of the number of standard deviations a data point is above or below a population mean. In such aspects, a z-score of 0 indicates that the data point is equal to the mean, a positive z-score indicates that the data point is above the mean, and a negative z-score indicates that the data point is below the mean. Accordingly, each z-score can be used to measure the variability of an observed data point. In such aspects, a z-score may be used to evaluate a return attributable to a risk factor relative to a mean return attributable to that risk factor.

According to further aspects, the portfolio scoring application 126 may evaluate the risk factor's subsequent returns by different periods. This is completed by running an “event study” on either factor selection or specific return selection. Illustrative event studies include, for example, what do returns look like after a certain period of time (e.g., a day, a week, a month, a year, etc.) when a risk factor like energy or market beta is purchased: Average returns and a confidence interval, given sufficient data, can be generated.

According to yet further aspects, the portfolio scoring application 126 may apply received trading data (e.g., for all retail investors that transmit their trading data to the TPRRS 106) to a machine learning algorithm (e.g., Adaptive Boosting, a Boosted Gradient Regression, a Support Vector Machine, and/or the like) to generate a machine-learning score (e.g., ML Score 314 of FIG. 3) that predicts each retail investor's future risk factor returns and/or to rank each retail investor relative to other retail investors.

According to various aspects, the portfolio scoring application 126 may initially normalize each retail investor's time series of risk factor exposures based on the time series of risk factor exposures determined for other retail investors. For example, each retail investor's time series of risk factor exposures may be regressed by an average of the other time series of risk factor exposures of the other retail investors to analyze each retail investor's residual time series of risk factor exposures. In such an aspect, the above-described analytics (e.g., Sharpe ratios, z-scores, machine learning score, and/or the like) may be recomputed.

At block 410, the portfolio scoring application 126 may generate a TPRRS risk factor selection score (e.g., TenPas Risk Factor Selection Score 316 of FIG. 3) for the retail investor (e.g., Retail Investor A). According to aspects of the present disclosure the retail investor's TPRRS risk factor selection score may be a function of the various analytics (e.g., risk factor selection scores) generated for the investor's time series of risk factor exposures. For example, one or more than one of the generated Sharpe ratio, the generated z-score, the generated machine learning score, or the like may be weighted to generate the TPRRS risk factor selection score (e.g., TenPas Risk Factor Selection Score 316). For example, referring to FIG. 3, the TenPas Risk Factor Selection Score may be generated as: 0.2 (0.3969)+0.3 (0.5)+0.5 (8.0)=4.2294. It should be understood that such weightings are examples and that other weightings may be similarly utilized in line with the present disclosure.

At block 412, the portfolio scoring application 126 may generate at least one ex-ante risk factor performance confidence interval (e.g., Confidence Interval 318 of FIG. 3). According to aspects of the present disclosure, the portfolio scoring application 126 may analyze (e.g., via a linear regression, a gradient boosted regression, a support vector machine, a supervised learning technique, and/or the like) a plurality of time series of risk factor exposures associated with a plurality of retail investors to generate a particular retail investor's (e.g., Retail Investor A's) ex-ante risk factor performance confidence interval. Such an analysis may be performed by the portfolio scoring application 126 on a rolling basis. The generated ex-ante risk factor performance confidence interval may be used to evaluate the retail investor's future risk factor selection ability and/or expected performance. More specifically, the ex-ante risk factor performance confidence interval may be used to assess which retail investor(s) are likely to outperform the relevant market in the future. In one example, a recruiter associated with the recruiter system 108 may evaluate the ex-ante risk factor performance confidence interval during their hiring decisions. In another example, a portfolio manager associated with the asset management system 110 may use the ex-ante risk factor performance confidence interval to determine one or more than one retail investor to track when developing trading strategies for a statistical arbitrage portfolio, a systematic strategy portfolio, quantitative strategy portfolio, or the like.

At block 414, the portfolio scoring application 126 may decompose the time series of security exposures into a time series of risk-factor-normalized security exposures (e.g., risk-neutral exposures that are not risk-seeking but also that are not risk-averse). To compute the retail investor's risk-adjusted, security-wise exposure, the portfolio scoring application 126 may regress risk factor exposures by security (see block 406) out of the retail investor's holdings each day. This residual is the risk-factor-neutral or risk-factor-normalized security exposure by security by day.

At block 416, the portfolio scoring application 126 may generate analytics based on the retail investor's time series of risk-factor-normalized security exposures to evaluate the retail investor's (e.g., Retail Investor A's) historical security selection ability and/or performance. More specifically, various returns attributable to the stock selection may be computed by the portfolio scoring application 126 and various analytics may be generated by the portfolio scoring application 126 based on the investor's stock selection exposures by day and attribution by stock selection exposure by day. According to various aspects, such analytics may be generated by sector, by country, and/or subclass of security. Such analytics may be generally referred to herein as security selection scores.

According to some aspects, the portfolio scoring application 126 may calculate the Sharpe ratio of the retail investor's returns (e.g., past performance) from the risk-factor-normalized security exposures (e.g., Sharpe Ratio 320 of FIG. 3). In other aspects, the portfolio scoring application 126 may calculate the retail investor's returns attributed to each risk-factor-normalized security exposure. In further aspects, the portfolio scoring application 126 may assess the retail investor's ability to predict security returns relative to other retail investors (e.g., Retail Investor B, Retail Investor N, and/or the like).

According to other aspects, the portfolio scoring application 126 may, in a similar manner as described herein, z-score each retail investor's risk-factor-normalized security exposures on a time-wise basis (e.g., Z-Score 322 of FIG. 3).

According to further aspects, the portfolio scoring application 126 may apply received trading data (e.g., for all retail investors that transmit their trading data to the TPRRS 106) to a machine learning algorithm (e.g., Adaptive Boosting, a Boosted Gradient Regression, a Support Vector Machine, and/or the like) to generate a machine-learning score (e.g., ML Score 324 of FIG. 3) that predicts each retail investor's future security selection returns and/or to rank each retail investor relative to other retail investors.

According to yet further aspects, the portfolio scoring application 126 may initially normalize each retail investor's time series of risk-factor-normalized security exposures based on the time series of risk-factor-normalized security exposures computed for other retail investors. For example, each retail investor's time series of risk-factor-normalized security exposures may be regressed by an average of the other time series of risk-factor-normalized security exposures of the other retail investors to analyze each retail investor's residual time series of risk-factor-normalized security exposures. In such an aspect, the above-described analytics (e.g., Sharpe ratios, z-scores, machine learning score, and/or the like) may be recomputed.

At block 418, the portfolio scoring application 126 may generate a TPRRS security selection score (e.g., TenPas Security Selection Score 326 of FIG. 3) for the retail investor (e.g., Retail Investor A). According to aspects of the present disclosure the investor's TPRRS security selection score may be a function of the various analytics (e.g., security selection scores) generated for the retail investor's time series of risk-factor-normalized security exposures. For example, one or more than one of the generated Sharpe ratio, the generated z-score, the generated machine learning score, or the like may be weighted to generate the TPRRS security selection score (e.g., TenPas Security Selection Score 326). For example, referring to FIG. 3, the TenPas Security Selection Score may be generated as: 0.5 (1.587)+0.2 (1.2)+0.3 (1.5)=1.4835. It should be understood that such weightings are examples and that other weightings may be similarly utilized in line with the present disclosure.

At block 420, the portfolio scoring application 126 may generate at least one ex-ante security selection performance confidence interval (e.g., Confidence Interval 328 of FIG. 3). According to aspects of the present disclosure, the portfolio scoring application 126 may analyze (e.g., via a linear regression, a gradient boosted regression, a support vector machine, a supervised learning technique, and/or the like) a plurality of time series of risk-factor-normalized security exposures associated with a plurality of retail investors to generate a particular retail investor's (e.g., Retail Investor A's) ex-ante security selection performance confidence interval. Such an analysis may be performed by the portfolio scoring application 126 on a rolling basis. The generated ex-ante security selection performance confidence interval may be used to evaluate the retail investor's future security selection ability and/or expected performance. More specifically, the ex-ante security selection performance confidence interval may be used to assess which retail investor(s) are likely to select securities that outperform the relevant market in the future. In one example, a recruiter associated with the recruiter system 108 may evaluate the ex-ante security selection performance confidence interval during their hiring decisions. In another example, a portfolio manager associated with the asset management system 110 may use the ex-ante stock selection performance confidence interval to determine one or more than one retail investor to track when developing trading strategies for a statistical arbitrage portfolio, a systematic strategy portfolio, quantitative strategy portfolio, or the like.

At block 422, the portfolio scoring application 126 may generate an aggregate TPRRS rating (e.g., Aggregate TenPas Rating 328 of FIG. 3) for the retail investor (e.g., Retail Investor A). According to aspects of the present disclosure the investor's aggregate TPRRS rating may be a function of the retail investor's TPRRS risk factor selection score (e.g., TenPas Risk Factor Selection Score 316) and the retail investor's TPRRS security selection score (e.g., TenPas Security Selection Score 326). For example, the retail investor's TPRRS risk factor selection score and the retail investor's TPRRS security selection score may be weighted to generated the Aggregate TenPas Rating 328. For example, referring to FIG. 3, the Aggregate TenPas Rating 328 may be generated as: 0.8 (4.2294)+0.2 (1.4835)=3.6802. According to some aspects, various ranges of the aggregate TPRRS rating may be associated with a particular letter rating (e.g., 0 to 2.0—A rating, 2.1 to 4.0—B rating, 4.1-6.0—C rating, and/or the like). Furthermore in such aspects, each letter rating may be a positive, neutral, or negative rating based on where the aggregate TPRRS rating falls within the range. It should be understood that such weightings, ranges, letter ratings, and/or the like are examples and that other ranges and/or letter ratings may be similarly utilized in line with the present disclosure.

According to additional aspects of the present disclosure, the portfolio scoring application 126 may further analyze, on an ongoing basis, one or more than one of the time series of risk factor exposures (block 406), the generated analytics for the time series of risk factor exposures (block 408), the generated TPRRS risk factor selection score (block 410), the generated ex-ante risk factor performance confidence interval (block 412), the time series of risk-factor-normalized security exposures (block 414), the generated analytics for the time series of risk-factor-normalized security exposures (block 416), the generated TPRRS security selection score (block 418) and the generated ex-ante security selection performance confidence interval (block 420) of each retail investor to compute exposure and return correlations with other retail investors (e.g., randomly chosen groups of retail investors, and/or the like). According to various aspects, the correlations may be stored in the database 118 for use in a relative scoring algorithm and/or for ranking more than one retail investor (e.g., via a recruiter dashboard application 138 and/or an alpha capture application 140, and/or the like).

### EXAMPLES

### Example 1: Lack of Trading History and/or Statistical Significance

According to aspects of the present disclosure, the portfolio scoring application 126 may be configured to require a threshold predetermined number of trades (e.g., at least 20 trades) and/or a threshold predetermined term of trading data (e.g., 6 months of trading data, consecutive months and/or in total) to compute a portfolio score and/or a confidence interval.

In a first example, a retail investor (e.g., Retail Investor A) may register with the TPRRS 106 and/or authorize their broker system (e.g., Broker System 104A) to transmit their current and ongoing trading data (e.g., not historical trading data), via an API (e.g., API 134A) to the TPRRS 106. In such an example, over the course of three months, the retail investor (e.g., Retail Investor A) may execute a total of 50 trades. Continuing the example, the portfolio scoring application 126 may not compute the portfolio score and/or the confidence interval for the retail investor's portfolio. In such an example, although the retail investor's 50 trades exceeds the threshold of 20 trades, the retail investor's three months of trading data is insufficient to accurately compute their portfolio score and/or their confidence interval.

### Example 2: Lack of Trading History and/or Statistical Significance

According to further aspects of the present disclosure, the portfolio scoring application 126 may be configured to require a threshold predetermined number of trades (e.g., at least 20 trades) and/or a threshold predetermined term of return data (e.g., one year, consecutive and/or in total, of return data) to compute the portfolio score and/or the confidence interval.

In a second example, a retail investor (e.g., Retail Investor B) may register with the TPRRS 106 and/or authorize their broker system (e.g., Broker System 104B) to transmit their current and ongoing trading data (e.g., not historical trading data), via an API (e.g., API 134B), to the TPRRS 106. In such an example, over the course of two years, the retail investor (e.g., Retail Investor B) may execute a total of 10 trades. Continuing the example, the portfolio scoring application 126 may not compute a portfolio score and/or a confidence interval for the retail investor's portfolio. In such an example, although the retail investor's two years of trading data permits the determination of two years of return data, the retail investor's 10 trades is insufficient to accurately compute their portfolio score and/or their confidence interval.

### Example 3: Specific Index and/or Predetermined Holding Period

According to other aspects of the present disclosure, the portfolio scoring application 126 may be configured to require further predetermined constraints prior to computation of a portfolio score and/or a confidence interval. In some aspects, a predetermined constraint may include the consideration of only trades executed on securities listed on a specific stock index (e.g., the Russell 1000 Index). Accordingly, the portfolio scoring application 126 of the present disclosure may be customized for a specific stock index. In further aspects, a predetermined constrain may include the considerations of only securities held for less than or equal to a predetermine number of days (e.g., 63 business days). In such aspects, it may be assumed that an investor's “best guess” as to the performance of a security is based off of “X” days (e.g., business days) of returns after a decision to purchase the security or a decision to sell the security. Aspects of the present disclosure assess the retail investor's ability to optimally purchase and/or sell securities. In general, retail investors may not be focused on long-held positions and/or long-term trades. Accordingly, the portfolio scoring application 126 may treat a security purchase as an investor's prediction that the security's market share price will increase and a security sale as the investor's prediction that the security's market share price will decrease. Furthermore, the portfolio scoring application 126 may be configured to exclude from consideration any position held by the investor for more than the predetermined number of days (e.g., 63 business days).

In a third example, a retail investor (e.g., Retail Investor N−1) may register with the TPRRS 106 and/or authorize their broker system (e.g., Broker System 104N−1) to transmit their current and ongoing trading data (e.g., not historical trading data), if any, at the end of every 504 business days, via an API (e.g., API 134N−1), to the TPRRS 106. Accordingly, at the end of every 504 business days, the TPRRS 106 may receive (e.g., a batch downloaded by TPRRS 106 and/or uploaded by the API 134N−1) the retail investor's trading data, if any, for the previous 504 business days. The TPRRS 106 may time-stamp and save each trade as described herein. In one example batch of trading data, over the course of two years, the retail investor (e.g., Retail Investor N−1) may execute a total of 120 trades, 100 of which are in the Russell 1000 Index. In such an example, the portfolio scoring application 126 may be configured to initially exclude the 20 trades not associated with the Russell 1000 Index. The portfolio scoring application 126 may be further configured to, for each of the 100 remaining trades and for the 63 business days after the purchase (e.g., starting the day after the purchase) of each of the 100 remaining trades, increase a long amount (e.g., from 0 or from a value based on previous trades) by the trade value divided by the total portfolio value (e.g., exposure adjustment for each trade). As described herein, the portfolio scoring application 126 may generate a two-dimensional array of security exposures. The first dimension may include the 1000 stocks in the Russell 1000 Index and the second dimension may include the investor's (e.g., Retail Investor N−1's) 504 business days' worth of exposures for stocks in the Russell 1000 Index.

Continuing the third example, the portfolio scoring application 126 may be further configured to compute, for each day and for each stock, various returns including a total return, a factor return, and/or a specific return. The total return may be determined each day for each stock by computing the sum of each stock exposure by the price return of the respective stock. The factor return may be determined each day for each stock by computing the sum of each stock exposure by its factor exposure, to generate a combined exposure for the portfolio to a factor. This combined portfolio factor exposure may be multiplied by the factor's return each day. In some aspects, the factor exposures and/or the factor returns each day may be a product of a risk model and is generally outside the scope of the present disclosure. Illustrative examples of risk models include, but are not limited to, Barra USE4, Axioma AXUS4, and other risk models covering countries, regions, and globally. The specific return may be determined each day for each stock by computing the total return minus the factor return. Each specific return is a return not explained by the factor return. Specific return may reflect the investor's (e.g., Investor N−1's) stock selection return. Accordingly, the portfolio scoring application 126 may generate a time series of 504 daily specific returns and 504 daily factor returns, which sum to the total returns for the investor's portfolio.

Continuing the third example, the portfolio scoring application 126 may be further configured to compute the investor's (e.g., Retail Investor N−1's) factor selection return. According to various aspects, the investor's factor selection return may be determined by computing an average of each of the investor's factor exposures over the two years, and subtracting them from the factor returns performance. In such aspects, a natural growth of the investor's portfolio due to risk factor exposure may be separated from the investor's ability to predict the performance of risk factors on an ex-ante basis.

Continuing the third example, the portfolio scoring application 126 may generate a time series of 504 daily specific returns and a time series of 504 daily factor selection returns. In such aspects, the portfolio scoring application 126 may be further configured to compute: (1) a realized daily variance of the specific return, and (2) a realized mean daily specific return (e.g., for the time series of 504 daily specific returns), as well as (1) a realized daily variance of the factor selection return, and (2) a realized mean daily factor selection return (e.g., for the time series of 504 daily factor selection returns). Accordingly, for purposes of the third example as described herein, the realized daily variance of the specific return may be computed as 0.0001 and the realized mean daily specific return may be computed as 0.001. Similarly, the realized daily variance of the factor selection return may be computed as 0.0001 and the realized mean daily factor selection return may be computed as 0.001.

Continuing the third example, the portfolio scoring application 126 may be further configured to generate various analytics. For example, a Sharpe ratio (e.g. a Specific Return (Stock Selection) Sharpe Ratio, a Factor Selection Sharpe Ratio, and/or the like) may be computed for the investor as follows:

$$Specific Return ( Stock Selection ) and Factor Selection Sharpe Ratio = \frac{Annualized Return}{Annualized Volatility} = \frac{Realized Mean Daily Return * 252}{\sqrt{Realized Daily Variance * 252}} = \frac{0.001 * 252}{\sqrt{0.0001 * 252}} = 1.587$$

Furthermore, a standard error of the calculated Sharpe Ratio may be computed as follows:

$$Standard Error ( Sharpe ) = \frac{\sqrt{252}}{\sqrt{\# of daily return samples}} = \frac{\sqrt{252}}{\sqrt{504}} = \frac{1}{\sqrt{2}} = 0.707$$

In such aspects, the statistical analyses of the present disclosure may assume that each stock's returns are independent and identically distributed and normally distributed. Furthermore, the statistical analyses of the present disclosure may assume that the investor's returns due to factor selection and stock selection are exogenous and constant over time. More specifically, different investors may have exogenous investment and return profiles under all market scenarios. In particular, an investor's realized rate of return may be constant, their variance may be constant, and neither may vary over time. Therefore, future returns and future volatility can be inferred from past returns and past volatility.

In this vein, continuing the third example, the portfolio scoring application 126 may be further configured to generate the investor's confidence interval. For example, an ex-ante 95% two-standard error confidence interval for the investor's future returns both in factor selection and stock selection may be computed as follows:

Specific Return (Stock Selection) and Factor Selection Confidence Interval: [1.587−2*0.707, 1.587+2*0.707]=[0.173, 3.001]

According to aspects of the present disclosure, as described herein, the TPRRS 106 may provide the retail investor (e.g., Retail Investor N−1) a customized hyperlink which the retail investor may share (e.g., with a recruiter). The customized hyperlink may link to portfolio scoring application 126 computations including the investor's Sharpe ratios, confidence intervals, and time series of specific returns, factor returns, total returns, and/or the like.

### Example 4: Modified Example 3

In a fourth example, the third example may be modified such that in one example batch of trading data, over the course of four years, a retail investor (e.g., Retail Investor N) may execute a total of 200 trades, 100 of which are in the Russell 1000 Index. In such an example, the portfolio scoring application 126 may be configured to initially exclude the 100 trades not associated with the Russell 1000 Index. Further, in a fourth example, the third example may be modified such that, for purposes of the fourth example, the realized daily variance of the specific return may remain 0.0001 and the realized mean daily specific return may remain 0.001 while the realized daily variance of the factor selection return may be computed as 0.0004 and the realized mean daily factor selection return may be computed as 0.0005.

Continuing the fourth example, the portfolio scoring application 126 may be similarly configured to generate various analytics. For example, the Specific Return (Stock Selection) Sharpe Ratio and the Factor Selection Sharpe Ratio may be computed for an investor (e.g., Retail Investor N) as follows:

$$Specific Return ( Stock Selection ) Sharpe Ratio = \frac{0.001 * 252}{\sqrt{0.0001 * 252}} = 1.587$$

$$Factor Selection Sharpe Ratio = \frac{0.0005 * 252}{\sqrt{0.0004 * 252}} = 0.3969$$

Furthermore, a standard error for each calculated Sharpe Ratio may be computed as follows:

Standard

$$Error ( Sharpe Ratio ) = \frac{\sqrt{252}}{\sqrt{\# of daily return samples}} = \frac{\sqrt{252}}{\sqrt{1008}} = \frac{1}{2} = 0.5$$

In this vein, continuing the fourth example, the portfolio scoring application 126 may be further configured to generate the investor's confidence interval for each calculated Sharpe ratio. For example, an ex-ante 95% two-standard error confidence interval for the investor's (e.g., Retail Investor N) future returns both in factor selection and stock selection may be computed as follows:

Specific Return (Stock Selection) Confidence Interval: [1.587−2*0.5, 1.587+2*0.5]=[0.587, 2.587]

Factor Selection Confidence Interval: [0.3969−2*0.5, 0.3969+2*0.5]=[−0.6031, 1.3969]

According to various aspects of the present disclosure, as more investors (e.g., Investors A, B, N) provide their trading data (e.g., historical, current, and/or ongoing) to the TPRRS 106, the portfolio scoring application 126 may be configured to generate further models to predict investor performance. In some aspects, the portfolio scoring application 126 may consider investor performance conditioned on different market environments. In further aspects, the portfolio scoring application 126 may consider whether recent retail investor performance better predicts future performance than historical returns. In still further aspects, the portfolio scoring application 126 may compare the computed ex-ante confidence intervals against actual realized results by the retail investor to modify the statistical models being utilized.

It should now be understood that the systems and methods described herein are suitable for technologically accessing historical, current, and/or ongoing retail investor brokerage account trading data. In particular, via an API as described herein, an independent third-party rating and recruiting system TPRRS may receive and analyze retail investor brokerage account trading data to rate the performance of individual retail investors. A recruiter system and/or an asset management system may then access such ratings for recruiting purposes and/or for alpha capture purposes.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A retail investor rating and recruiting system, comprising:
a third-party rating and recruiting system (TPRRS), including:
a processor;
a storage device;
an application programming interface (API) stored in the storage device, wherein the API defines one or more than one command invokable to initiate the transmission of brokerage account trading data from a broker system, associated with one or more than one retail investor, to the TPRRS; and
a memory storing program instructions that, when executed by the processor cause the TPRRS to:
analyze the brokerage account trading data associated with at least one retail investor to generate at least one of a retail investor performance metric or a retail investor rating for each retail investor; and
transmit the at least one of the retail investor performance metric or the retail investor rating to a recipient device.

2. The system of claim 1, wherein the recipient device includes at least one of a retail investor device, an asset management system, or a recruiter system communicatively coupled to the TPRRS.

3. The system of claim 1, wherein the brokerage account trading data includes at least one of historical brokerage account trading data, current brokerage account trading data, or ongoing brokerage account trading data.

4. The system of claim 3, further comprising:
a retail investor device, wherein the retail investor device is configured to display a graphical user interface (GUI) and is configured to receive, via the GUI, a retail investor's selection to transmit the at least one of the historical brokerage account trading data, the current brokerage account trading data, or the ongoing brokerage account trading data to the TPRRS.

5. The system of claim 4, wherein the retail investor device is further configured to receive, via the GUI, the retail investor's selection of a frequency associated with the transmitting of the ongoing brokerage account trading data.

6. The system of claim 1, wherein the program instructions, when executed by the processor, cause the TPRRS to generate at least the retail investor performance metric, wherein the retail investor performance metric includes:
one or more than one risk factor selection score generated based on a time series of risk factor exposures derived from the brokerage account trading data associated with each respective retail investor; and
one or more than one security selection score generated based on a time series of risk-factor-normalized security exposures derived from the brokerage account trading data associated with each respective retail investor.

7. The system of claim 6, wherein the program instructions, when executed by the processor, further cause the TPRRS to generate:
a TPRRS risk factor selection score as a weighted combination of the one or more than one risk factor selection score; and
a TPRRS security selection score as a weighted combination of the one or more than one security selection score.

8. The system of claim 7, wherein the program instructions, when executed by the processor, cause the TPRRS to further generate the retail investor rating, wherein the retail investor rating includes:
a TPRRS retail investor rating generated based on the TPRRS risk factor selection score and the TPRRS security selection score.

9. The system of claim 1, further comprising:
an investor dashboard application stored in the storage device, wherein the investor dashboard application is downloadable by a communicatively coupled retail investor device, and wherein the investor dashboard application is configured to display a retail investor dashboard GUI on the retail investor device, the retail investor dashboard GUI including the at least one of the retail investor performance metric or the retail investor rating generated by the TPRRS for a retail investor associated with the retail investor device.

10. The system of claim 9, wherein the investor dashboard application is further configured to provide a customized hyperlink generated by the TPRRS, the customized hyperlink selectable to link a recipient to the at least one of the retail investor performance metric or the retail investor rating generated by the TPRRS for the retail investor based on the retail investor's brokerage account trading data.

11. The system of claim 10, wherein the retail investor dashboard GUI is configured to send the retail investor's customized hyperlink to the recipient.

12. The system of claim 1, further comprising:
a recruiter dashboard application stored in the storage device, wherein the recruiter dashboard application is downloadable by a communicatively coupled recruiter system, and wherein the recruiter dashboard application is configured to display a recruiter dashboard GUI on the recruiter system, the recruiter dashboard GUI including the at least one of the retail investor performance metric or the retail investor rating generated by the TPRRS for at least one of a plurality of retail investors.

13. The system of claim 1, wherein the API is downloadable by a communicatively coupled broker system, and wherein the one or more than one command defined by the API is invokable by the broker system to automatically transmit a retail investor's brokerage account trading data to the TPRRS.

14. The system of claim 1, wherein the one or more than one command defined by the API is invokable by the TPRRS to request a retail investor's brokerage account trading data from a broker system.

15. A retail investor rating and recruiting system, comprising:
a third-party rating and recruiting system (TPRRS), including:
a storage device;
an application programming interface (API) stored in the storage device, wherein the API defines one or more than one command invokable to initiate the transmission of brokerage account trading data from a broker system to the TPRRS, and wherein the API is downloadable by one or more than one communicatively coupled broker system.

16. The system of claim 15, wherein the TPRRS further includes:
a processor; and
a memory storing program instructions that, when executed by the processor cause the TPRRS to:
generate at least one of a retail investor performance metric or a retail investor rating for a retail investor associated with the retail investor's brokerage account trading data; and
generate a customized hyperlink selectable to link a recipient to the at least one of the retail investor performance metric or the retail investor rating.

17. The system of claim 15, wherein the one or more than one command defined by the API is invokable by the one or more than one broker system to automatically transmit retail investor brokerage account trading data to the TPRRS.

18. The system of claim 15, wherein the one or more than one command defined by the API is invokable by the TPRRS to request a retail investor's brokerage account trading data from one or more than one broker system.

19. A retail investor rating and recruiting method, comprising:
receiving from a broker system, via an application programming interface (API) of a third-party rating and recruiting system (TPRRS), brokerage account trading data associated with one or more than one retail investor, wherein the API defines one or more than one command invokable to initiate the transmission of the brokerage account trading data from the broker system to the TPRRS;
analyzing, by the TPRRS, the brokerage account trading data associated with at least one retail investor to generate at least one of a retail investor performance metric or a retail investor rating for each retail investor; and
transmitting, by the TPRRS, the at least one of the retail investor performance metric or the retail investor rating to a recipient device.

20. The method of claim 19, wherein the recipient device includes at least one of a retail investor device, an asset management system, or a recruiter system.
